(19) United States
(12) Patent Application Publication
(10) Pub. No.: US 2025/0356309 A1
(43) Pub. Date: Nov. 20, 2025

(54) ORDER INFORMATION MANAGEMENT METHOD, DEVICE, AND SYSTEM, ELECTRONIC APPARATUS AND STORAGE MEDIUM

(71) Applicant: Beijing Youzhuju Network Technology Co., Ltd., Beijing (CN)

(72) Inventor: Zishuo LIU, Beijing (CN)

(21) Appl. No.: 18/868,686

(22) PCT Filed: Apr. 18, 2023
(86) PCT No.: PCT/CN2023/088989

§ 371 Date: Nov. 22, 2024

(30) Foreign Application Priority Data
May 24, 2022 (CN) 202210572166.5

(51) Int. Cl. G06Q 10/087

(52) U.S. Cl. CPC G06Q 10/0874

(57) ABSTRACT

The embodiment of the present disclosure provides an order information management method, device, and system, an electronic apparatus and a storage medium, the method includes: in response to obtaining a message of a new order of a target user on at least one first-type information platform, synchronizing order information of the new order to a second-type information platform of the target user; in response to obtaining an order status update message of the new order, synchronizing updated order status information of the new order from a message source terminal on the first-type information platform and the second-type information platform to a non-message source terminal, so as to complete synchronous management of the order information, the first-type information platform and the second-type information platform are different order information sources and different information management platforms of the target user, the second-type information platform is a main order information summary management platform.

The present application claims priority of the Chinese Patent Application No. 202210572166.5 filed in China Patent Office on May 24, 2022, the contents of which are incorporated herein by reference in its entirety to the present application.

### TECHNICAL FIELD

Embodiments of the present disclosure relates to the technical field of computer, such as an order information management method, device, and system, an electronic apparatus and a storage medium.

### BACKGROUND

At present, many merchants not only set up shops on traditional B2C (business to customer) e-commerce platforms, but also set up shops in independent stations in the form of Direct-to-Consumer (DTC), so as to create personalized brand culture and services, which requires merchants to manage order information of the independent stations and stores on various e-commerce platforms at the same time.

However, the unified management of order information on different platforms mostly relies on the third-party ERP (Enterprise Resource Planning) system to manage the order information indirectly, and the compatibility of information from all parties and the efficiency of information processing need to be improved.

### SUMMARY

The present disclosure provides an order information management method, device, and system, an electronic apparatus and a storage medium.

The first aspect, at least one embodiment of the present disclosure provides an order information management method, and the method comprises:
in response to obtaining a message of a new order of a target user on at least one first-type information platform, synchronizing order information of the new order to a second-type information platform of the target user; and
in response to obtaining an order status update message of the new order, synchronizing updated order status information of the new order from a message source terminal on the first-type information platform and the second-type information platform to a non-message source terminal, so as to complete synchronous management of the order information,
in which, the first-type information platform and the second-type information platform are different order information sources and different information management platforms of the target user, and the second-type information platform is a main order information summary management platform.

The second aspect, at least one embodiment of the present disclosure further provides an order information management device, and the device comprises:
a new order synchronization module, configured to, in response to obtaining a message of a new order of a target user on at least one first-type information platform, synchronize order information of the new order to a second-type information platform of the target user; and
an order status synchronization module, configured to, in response to obtaining an order status update message of the new order, synchronize updated order status information of the new order from a message source terminal on the first-type information platform and the second-type information platform to a non-message source terminal, so as to complete synchronous management of the order information,
in which the first-type information platform and the second-type information platform are different order information sources and different information management platforms of the target user, and the second-type information platform is a main order information summary management platform.

The third aspect, at least one embodiment of the present disclosure further provides an order information management system, and the system comprises:
at least one first-type information platform, one second-type information platform and an order management device running on the first-type information platform,
in which the first-type information platform and the second-type information platform are different order information sources and different information management platforms of a same target user, and the second-type information platform is a main order information summary management platform;
the order management device is configured to realize synchronous management of the order information of the first-type information platform between the first-type information platform and the second-type information platform through the order information management method according to any one of the above embodiments.

The fourth aspect, at least one embodiment of the present disclosure further provides an electronic apparatus, and the electronic apparatus comprises:
one or more processors;
a storage device, configured to store one or more programs,
upon the one or more programs being executed by the one or more processors, the one or more processors realize the order information management method according to any one of the embodiments of the present disclosure.

The fifth aspect, at least one embodiment of the present disclosure further provides a storage medium containing computer executable instructions, and the computer executable instructions is used for executing the order information management method according to any one of the embodiments upon the computer executable instructions being executed by a computer processor.

### BRIEF DESCRIPTION OF DRAWINGS

Throughout the drawings, the same or similar reference numerals indicate the same or similar elements. It should be understood that the drawings are schematic, and the original and elements are not necessarily drawn to scale.

FIG. 1 is a flowchart of an order information management method provided by an embodiment of the present disclosure;

FIG. 2 is a flowchart of another order information management method provided by an embodiment of the present disclosure;

FIG. 3 is a schematic structural diagram of an order information management device provided by an embodiment of the present disclosure;

FIG. 4 is a schematic structural diagram of an order information management system provided by an embodiment of the present disclosure;

FIG. 5 is a working timing diagram of an order information management system provided by an embodiment of the present disclosure;

FIG. 6 is a schematic structural diagram of an electronic apparatus provided by an embodiment of the present disclosure.

### DETAILED DESCRIPTION

It should be understood that various steps recorded in the implementation modes of the method of the present disclosure may be performed according to different orders and/or performed in parallel. In addition, the implementation modes of the method may include additional steps and/or steps omitted or unshown. The scope of the present disclosure is not limited in this aspect.

The term “including” and variations thereof used in this article are open-ended inclusion, namely “including but not limited to”. The term “based on” refers to “at least partially based on”. The term “one embodiment” means “at least one embodiment”; the term “another embodiment” means “at least one other embodiment”; and the term “some embodiments” means “at least some embodiments”. Relevant definitions of other terms may be given in the description hereinafter.

It should be noted that concepts such as “first” and “second” mentioned in the present disclosure are only used to distinguish different apparatuses, modules or units, and are not intended to limit orders or interdependence relationships of functions performed by these apparatuses, modules or units.

It should be noted that modifications of “one” and “more” mentioned in the present disclosure are schematic rather than restrictive, and those skilled in the art should understand that unless otherwise explicitly stated in the context, it should be understood as “one or more”.

It can be understood that before using the embodiments of the present disclosure, users should be informed of the types, scope of use, usage scenarios, etc. of personal information involved in the present disclosure in an appropriate way and be authorized by users.

For example, in response to receiving the user's active request, prompt information is sent to the user to clearly remind the user that the operation requested by the user will require obtaining and using the user's personal information. Therefore, the user can independently choose whether to provide personal information to software or hardware such as electronic devices, applications, servers or storage mediums that perform the operations of the embodiments of the present disclosure according to the prompt information.

As an optional but non-limiting implementation, in response to receiving the user's active request, the way to send the prompt information to the user may be, for example, a pop-up window, the prompt information may be presented in text in the pop-up window. In addition, the pop-up window may also carry selection controls for the user to choose “agree” or “disagree” to provide personal information to the electronic device.

It can be understood that the above process of notifying and obtaining user authorization is only schematic, and does not limit the implementation method of the present disclosure, and other ways to meet relevant laws and regulations may also be applied to the implementation method of the present disclosure.

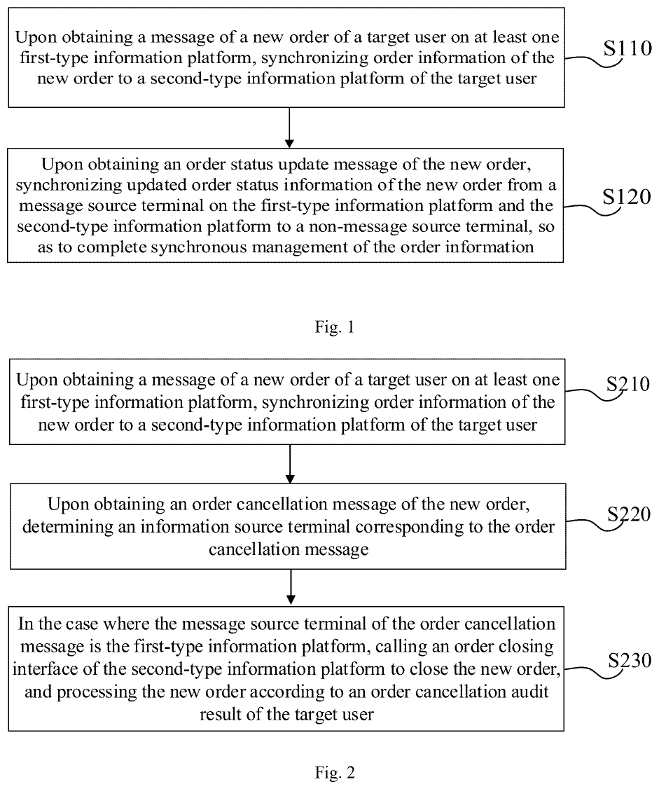

FIG. 1 is a flowchart of an order information management method provided by an embodiment of the present disclosure. The embodiment of the present disclosure can synchronously manage the order information of multiple information platforms, and the method can be executed by an order information management device which can be realized in the form of software and/or hardware, for example, realized by an electronic apparatus, and the electronic apparatus may be a mobile terminal, a Personal Computer (PC) terminal or a server, and so on.

As shown in FIG. 1, the order information management method includes:
S110: upon obtaining a message of a new order of a target user on at least one first-type information platform, synchronizing order information of the new order to a second-type information platform of the target user.

The first-type information platform and the second-type information platform are both information platforms used to display information of preset goods and standardize the process of goods circulation, and in the process of goods circulation, corresponding goods order information will be generated. The first-type information platform and the second-type information platform are different order information sources and information management platforms for the target user, and the second-type information platform is a main order information summary management platform. It can be understood that the second-type information platform is not only a platform for generating the goods order, but also a platform for summarizing and managing the orders from multiple information platforms of different types. Orders generated by the second-type information platform are managed on this platform, while orders generated by the first-type information platform are synchronized to the second-type information platform for management. Then, for the target user, the order information of multiple platforms can be managed through one second platform, and the efficiency of order processing and status tracking can be improved. The second-type information platform can be an information platform independently selected by the target users, which provides a greater self-management authority for the target user and is easier to realize a personalized setting platform, for example, an independent station. The first-type information platform may be a traditional B2C (business to customer) e-commerce platform.

For example, in any first-type information platform of the target user, after a new order is created and the payment operation is completed, the synchronization operation of the new order is triggered. The first-type information platform will send the message of the new order to a preset new order message queue, waiting for the synchronous operation of the order information management device. Accordingly, the order information management device will acquire the message of the new order of the target user on the first-type information platform in the new order message queue, and after obtaining the corresponding queue message, call an order information acquisition interface of the first-type information platform according to the order identification information carried in the message to read the detailed information of the new order. Furthermore, the order information management device will synchronize the obtained detailed information of the new order to the second-type information platform, and can further update the inventory information of the second-type information platform according to the detailed information of the new order. Therefore, the target user can view and manage the orders generated by the first-type information platform thereof on the second-type information platform, without jumping between different information platforms to check the order information and the inventory information.
S120: upon obtaining an order status update message of the new order, synchronizing updated order status information of the new order from a message source terminal on the first-type information platform and the second-type information platform to a non-message source terminal, so as to complete synchronous management of the order information.

After the new order information is synchronized to the second-type information platform, the new order will exist in both the first-type information platform that generates the order and the second-type information platform that performs order summary and fusion management, then, the change of the order status can be the result of automatic order processing of the first-type information platform or the status update generated by the target user's active operation on the second-type information platform. Therefore, the message source of the obtained order status update message may be the first-type information platform, or may be the second-type information platform. In order to keep the order status consistent in different information platforms and avoid repeated delivery or abnormal orders that cannot be processed in time, it is necessary to synchronize the updated order status information from the message source terminal to the non-message source terminal. What needs to be explained here is that the new order refers to all orders that have been synchronized from the first-type information platform to the second-type information platform, that is, all orders that exist in both the first-type information platform and the second-type information platform, not just the latest effective order. Every time the order status changes, the corresponding order status update message of each order that exists on the first-type information platform and the second-type information platform at the same time can be gotten, and the information of the each order can be updated and synchronized.

For example, in the case where the order status update message of the new order is an order fulfillment message, the order information management device will call a fulfillment interface of the message source terminal to obtain the updated order status information of the new order at the message source according to the information such as an order identification in the order fulfillment message, and then, call a fulfillment interface of the non-message source terminal to synchronize the updated order status information to the non-message source terminal.

In an embodiment, in the case where the message source terminal is the first-type information platform and the non-message source terminal is the second-type information platform, a kind of process of synchronizing the updated order status information of the new order from the message source terminal on the first-type information platform and the second-type information platform to the non-message source terminal is as follows: firstly, a fulfillment interface of the first-type information platform is called to obtain a fulfillment status and currently latest fulfillment related information of the new order according to information such as an order identification carried in the order fulfillment message. The process of order fulfillment may refer to the process of packing and leaving the warehouse, shipping and mailing, delivery, order signing and after-sales after the order takes effect. The fulfillment status includes pre-delivery, in-delivery, post-delivery and sign-for, and so on. The fulfillment related information includes the content such as the change time and logistics information of each fulfillment status and so on. After obtaining the fulfillment status of the new order and the latest fulfillment related information, the fulfillment interface of the second-type information platform is called to change the order status of the new order on the second-type information platform into the fulfillment status, and the fulfillment related information is updated. In the order fulfillment operation of the first-type information platform, usually the preset platform automatically fulfills the delivery, and the logistics provider cooperating with the platform will provide information such as logistics number and logistics progress and so on. During the synchronization of the order status update, the corresponding fulfillment information can be directly obtained from the first-type information platform and synchronized to the second-type information platform.

In the case where the message source terminal is the second-type information platform and the non-message source terminal is the first-type information platform, the process of synchronizing the updated order status information of the new order from the message source terminal on the first-type information platform and the second-type information platform to the non-message source terminal is as follows: first, a fulfillment interface of the second-type information platform is called to obtain a fulfillment status and initial fulfillment related information of the new order according to information such as an order identification carried in the order fulfillment message. The initial fulfillment related information refers to the relevant information of the target user when delivering goods on the second-type information platform, such as delivery time, logistics order number and other information. Then, a logistics service interface on the first-type information platform is called to obtain the latest fulfillment related information according to the initial fulfillment related information, such as obtaining more logistics transportation status information according to the logistics order number. Finally, a fulfillment interface on the first-type information platform is called to change an order status of the new order on the first-type information platform into the updated fulfillment status, and the latest fulfillment related information is updated. If so, in the case where the second-type information platform can directly obtain the latest fulfillment related information, the fulfillment interface on the first-type information platform can be directly called to synchronize the updated fulfillment information.

In one embodiment, in order to ensure the consistency of information between the first-type information platform and the second-type information platform, the order information management device may also perform an order synchronization record according to the message of the new order and the order status update message obtained each time, and then, according to the order synchronization record and each synchronization feedback record of the order, find the order information that fails to be synchronized, and re-synchronize the order information that fails to be synchronized. That is, according to a certain time frequency, the orders and order status between the first-type information platform and the second-type information platform are compared, and the order information of the order synchronized from the first-type information platform to the second-type information platform is kept in the same and in an up-to-date state on the two different platforms.

The embodiment of the present disclosure synchronizes the order information of the new order to the second-type information platform for the target user upon the message of the new order of the target user on at least one first-type information platform being obtained under the condition that the target user uses multiple information platforms, so as to realize the summary management of all order information on one main information platform; upon an order status update message of a new order being obtained, the updated order status information of the new order is synchronized from the message source terminal on the first-type information platform and the second-type information platform to the non-message source terminal to complete the synchronous management of the order information, so that the order status generated on the first-type information platform can be kept consistent with that on the corresponding first-type information platform and second-type information platform; the first-type information platform and the second-type information platform are different order information sources and information management platforms for the target user, and the second-type information platform is the main order information summary management platform, so that a user can manage the orders of this information platform and the order information from other information platforms on one second-type information platform at the same time without platform jump. The fulfillment operation of the order performed by the target user on the second-type information platform can also be updated to the corresponding first-type information platform synchronously, which realizes two-way information synchronization, avoids the situation of low information processing efficiency in the unified management of order information on different information platforms, realizes the order information fusion and two-way information synchronization of different types of e-commerce platforms, and improves the order information processing efficiency.

FIG. 2 is a flowchart of another order information management method provided by an embodiment of the present disclosure, and in the process of realizing the flow of this method, the order information management mode in a scene where the order is cancelled is described. The method can be executed by an order information management device which may be realized in the form of software and/or hardware, for example, realized by an electronic apparatus, and the electronic apparatus may be a mobile terminal, a PC terminal or a server, and so on.

As shown in FIG. 2, the order information management method includes:
S210: upon obtaining a message of a new order of a target user on at least one first-type information platform, synchronizing order information of the new order to a second-type information platform of the target user.
S220: upon obtaining an order cancellation message of the new order, determining an information source terminal corresponding to the order cancellation message.

After the order information of the new order is synchronized to the second-type information platform, the new order will exist in both the first-type information platform that generates the order and the second-type information platform that performs order summary and fusion management, then, the order cancellation message may be a message generated by the user, who placed the order, canceling the order on the first-type information platform or a message generated by the target user actively canceling the order on the second-type information platform. What needs to be explained here is that, in general, more users, who place the orders, cancel their orders on the first-type information platform, that is, in most cases, the message source terminal of the order cancellation message is the first-type information platform. In the second-type information platform, the target user cannot cancel the new order, whose payment has been completed by the user who placed the order, which is verified that the inventory is available, and whose order status has been set as to be shipped. Even if the target user cancels this order in the second-type information platform, the order cancellation status will not be synchronized to the first-type information platform. In the second-type information platform, the target users can be guided to avoid mis-operation through relevant business prompts. For the new order that the user who placed the order has completed payment and is verified that there is no inventory, the target user can cancel the order. In the present embodiment, the synchronization of the order cancellation message is aimed at the situation that the user who placed the order or the target user can cancel the order.
S230: in the case where the message source terminal of the order cancellation message is the first-type information platform, calling an order closing interface of the second-type information platform to close the new order, and processing the new order according to an order cancellation audit result of the target user.

In the case where the message source terminal of the order cancellation message is the first-type information platform, it is mostly the order cancellation operation initiated by the ordering user. For the request of order cancellation, the target user needs to further review to determine whether the order can be cancelled. The order information management device will call the order closing interface of the second-type information platform to close the new order to be confirmed whether to be cancelled, so as to remind the target user to suspend the order fulfillment. Upon the order information management device obtaining a message that the order cancellation audit of the target user on the second-type information platform is approved, the order information management device will call the order cancellation interface of the second-type information platform to cancel the new order and release the order inventory; upon the order information management device obtaining a message that the order cancellation audit of the target user on the second-type information platform fails, the order information management device will call an order restart interface of the second-type information platform to reopen the new order which has been closed, and perform a fulfillment operation according to a conventional fulfillment process.

In addition, if the setting of the first-type information platform is that the order can be cancelled automatically without auditing, the order information management device may call the order cancellation interface of the second-type information platform to cancel the order and release the inventory occupied by the items in the cancelled order.

In view of the situation that the target user can cancel the order, upon the order information management device obtaining the order cancellation message from the second-type information platform, the order information management device will call an order cancellation interface of the first-type information platform to close the cancelled order.

The embodiment of the present disclosure synchronizes the order information of the new order to the second-type information platform of the target user upon the message of the new order of the target user on at least one first-type information platform being obtained under the condition that the target user uses multiple information platforms, so as to realize the summary management of all order information on one main information platform; upon an order cancellation message of a new order being obtained, the order cancellation information is synchronously informed to the target user to suspend delivery, and the order is cancelled or reopened according to the order cancellation audit result of the target user, so that the synchronous management of the order information is completed, therefore the state of the order generated on the first-type information platform can be kept consistent with that on the corresponding first-type information platform and second-type information platform; the first-type information platform and the second-type information platform are different order information sources and information management platforms for the target user, and the second-type information platform is the main order information summary management platform, so that a user can manage the orders of this information platform and the order information from other information platforms on one second-type information platform at the same time without platform jump, which avoids the situation of low information processing efficiency in the unified management of order information of different information platforms, realizes order information fusion and two-way information synchronization of different types of e-commerce platforms, and improves the order information processing efficiency.

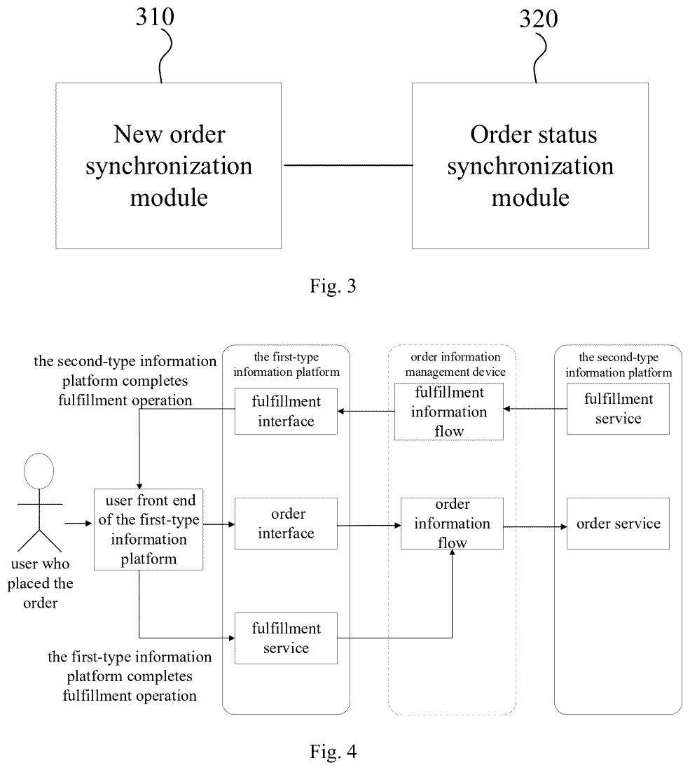

FIG. 3 is a schematic structural diagram of an order information management device provided by an embodiment of the present disclosure. The device is suitable for synchronous management of order information of multiple information platforms, and can be implemented in the form of software and/or hardware, for example, implemented by an electronic apparatus, and the electronic apparatus may be a mobile terminal, a PC terminal or a server, and so on.

As shown in FIG. 3, the order information management device includes a new order synchronization module 310 and an order status synchronization module 320.

The new order synchronization module 310 is configured to, upon obtaining a message of a new order of a target user on at least one first-type information platform, synchronize order information of the new order to a second-type information platform of the target user; the order status synchronization module 320 is configured to, upon obtaining an order status update message of the new order, synchronize updated order status information of the new order from a message source terminal on the first-type information platform and the second-type information platform to a non-message source terminal, so as to complete synchronous management of the order information; the first-type information platform and the second-type information platform are different order information sources and different information management platforms of the target user, and the second-type information platform is a main order information summary management platform.

The embodiment of the present disclosure synchronizes the order information of the new order to the second-type information platform for the target user upon the message of the new order of the target user on at least one first-type information platform being obtained under the condition that the target user uses multiple information platforms, so as to realize the summary management of all order information on one main information platform; upon an order status update message of a new order being obtained, the updated order status information of the new order is synchronized from the message source terminal on the first-type information platform and the second-type information platform to the non-message source terminal to complete the synchronous management of the order information, so that the order status generated on the first-type information platform can be kept consistent with that on the corresponding first-type information platform and second-type information platform; the first-type information platform and the second-type information platform are different order information sources and information management platforms for the target user, and the second-type information platform is the main order information summary management platform, so that a user can manage the orders of this information platform and the order information from other information platforms on one second-type information platform at the same time without platform jump, which avoids the situation of low information processing efficiency in the unified management of order information on different information platforms, realizes the order information fusion and two-way information synchronization of different types of e-commerce platforms, and improves the order information processing efficiency.

In an implementation method, the order status update message is an order fulfillment message, and the order status synchronization module 320 is configured to:
call a fulfillment interface of the message source terminal to obtain the updated order status information of the new order at the message source terminal according to the order fulfillment message; and
call a fulfillment interface of the non-message source terminal to synchronize the updated order status information to the non-message source terminal.

In an implementation method, in the case where the message source terminal is the first-type information platform and the non-message source terminal is the second-type information platform, the order status synchronization module 320 is further configured to:
call a fulfillment interface of the first-type information platform to obtain a fulfillment status and currently latest fulfillment related information of the new order according to the order fulfillment message; and
call a fulfillment interface of the second-type information platform to change an order status of the new order on the second-type information platform into the fulfillment status, and update the fulfillment related information.

In an implementation method, in the case where the message source terminal is the second-type information platform and the non-message source terminal is the first-type information platform, the order status synchronization module 320 is further configured to:
call a fulfillment interface of the second-type information platform to obtain a fulfillment status and initial fulfillment related information of the new order according to the order fulfillment message;
call a logistics service interface on the first-type information platform to obtain currently latest fulfillment related information according to the initial fulfillment related information; and
call a fulfillment interface on the first-type information platform to change an order status of the new order on the first-type information platform into the fulfillment status, and update the currently latest fulfillment related information.

In one embodiment, in the case where the order status update message is an order cancellation message, the order status synchronization module 320 is further configured to:
upon the message source terminal of the order cancellation message being the first-type information platform, call an order closing interface of the second-type information platform to close the new order, and process the new order according to a result of order cancellation audit of the target user.

In an implementation method, the order status synchronization module 320 is further configured to:
upon obtaining a message that the order cancellation audit of the target user on the second-type information platform is approved, call an order cancellation interface of the second-type information platform to cancel the new order and release an order inventory;
upon obtaining a message that the order cancellation audit of the target user on the second-type information platform fails, call an order restart interface of the second-type information platform to reopen the new order which has been closed.

In an implementation method, the order information management device further comprises an order synchronization checking module which is configured to:
perform an order synchronization record according to the message of the new order and the order status update message;
find order information that fails to be synchronized according to the order synchronization record and each synchronization feedback record, and re-synchronize the order information that fails to be synchronized.

The order information management device provided by the embodiment of the present disclosure can execute the order information management method provided by any one of the embodiments of the present disclosure, and has corresponding function modules and beneficial effects.

It is worth noting that each unit and module included in the above-mentioned device is only divided according to functional logic, but it is not limited to the above division, as long as the corresponding functions can be realized; in addition, the specific names of each function unit are only for the convenience of distinguishing each other, and are not used to limit the protection scope of the embodiments of the present disclosure.

FIG. 4 is a schematic structural diagram of an order information management system provided by an embodiment of the present disclosure, which can use any one of the order information management methods provided by the embodiments of the present disclosure to realize the integration and management of order information between systems.

As shown in FIG. 4, the order information management system includes at least one first-type information platform, one second-type information platform and an order management device running on each of the first-type information platform.

The first-type information platform and the second-type information platform are different order information sources and information management platforms of the same target user, and the second-type information platform is the main order information summary management platform, for example, the first-type information platform is a conventional e-commerce platform and the second-type information platform is an independent station. The order management device may be a function plug-in running on the first-type information platform, or an application device or system independently configured on a computer apparatus, which can be used to realize the order information management methods provided in the above embodiments and synchronously manage the order information of each first-type information platform between the first-type information platform and the second-type information platform.

It can be seen from FIG. 4, the order information management device, as an information transfer station between the first-type information platform and the second-type information platform, calls the open function interface between the first-type information platform and the second-type information platform to complete the synchronization of the corresponding new order information and the synchronization of the order status change information. When different information platforms complete the fulfillment operation, the direction of information flow is different.

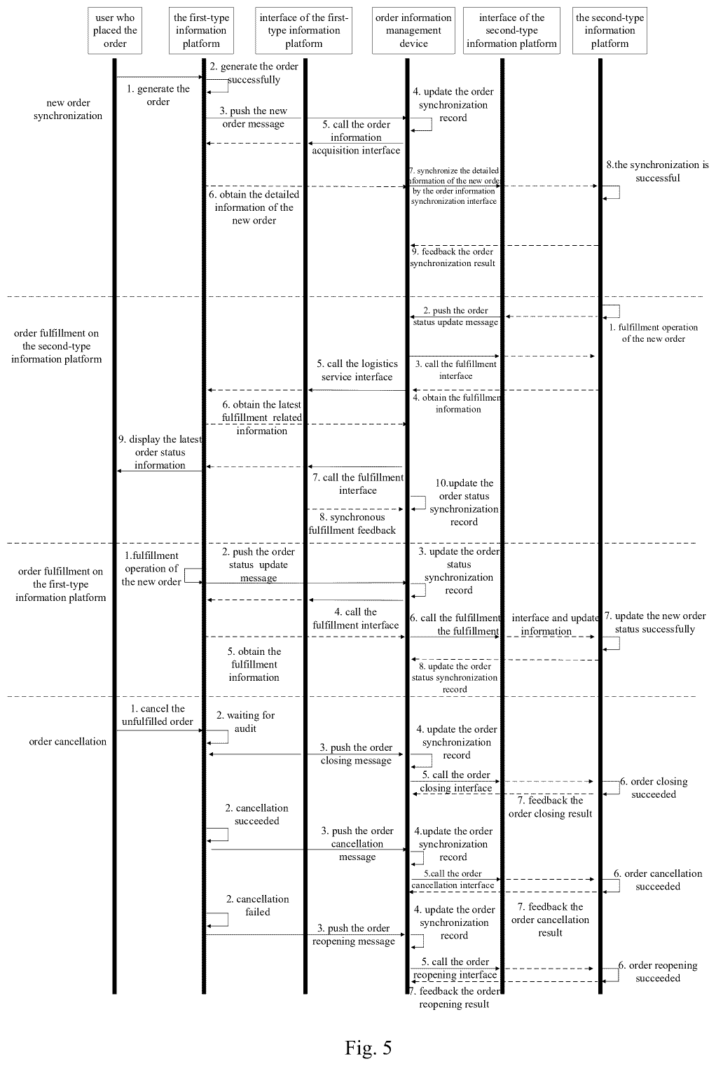

For example, the working timing diagram of the order information synchronization performed by the order information management system is shown in FIG. 5.

In the new order synchronization stage, first, the user who placed the order creates a new order on the first-type information platform, and the order is successfully generated on the first-type information platform; then, upon the generated order payment being completed, the first-type information platform sends the message of the new order to a preset new order message queue, waiting for the synchronous operation performed by the order information management device. Accordingly, the order information management device will obtain the message of the new order of the first-type information platform, update the order synchronization record after obtaining the corresponding queue message, and call the order information acquisition interface of the first-type information platform to read the detailed information of the new order according to the order identification information carried in the message. Furthermore, the order information management device will call the order information synchronization interface of the second-type information platform to synchronize the obtained detailed order information to the second-type information platform, and can also update the inventory information of the second-type information platform according to the detailed order information. Finally, the second-type of information platform synchronization system realizes the synchronization of the new order, and feeds back the order synchronization result to the order information management device (that is, whether the synchronization is successful or not). Therefore, the target users can view and manage the orders generated by their first-type information platforms on their corresponding second-type information platforms, without jumping between different information platforms to check the order information and inventory information.

In the fulfillment stage with the second-type information platform as the fulfillment operator, first, the target user (that is, the manager of the information platform operation) performs the fulfillment operation of the new order on the second-type information platform, and pushes the order status update message to the corresponding queue. The order information management device calls the fulfillment interface of the second-type information platform after obtaining the order status update message, and obtains the fulfillment status and initial fulfillment related information of the new order according to the information such as the order identification carried in the order fulfillment message. The initial fulfillment related information refers to the relevant information of the target user when delivering goods on the second-type information platform, such as delivery time, logistics order number and other information. Then, the order information management device calls a logistics service interface on the first-type information platform to obtain the latest fulfillment related information according to the initial fulfillment related information, such as obtaining more logistics transportation status information according to the logistics order number. Finally, the order information management device calls a fulfillment interface on the first-type information platform to change an order status of the new order on the first-type information platform into the updated fulfillment status, and updates the latest fulfillment related information. The first-type information platform performs synchronous fulfillment feedback to the order information management device, and displays the latest order status information to the user who placed the order at the front end of the platform. The order information management device updates the order status synchronization record according to the feedback result.

In an embodiment, in the fulfillment stage where the first-type information platform is the fulfillment operator, first, the first-type information platform automatically completes the fulfillment operation according to the automatic fulfillment setting, and pushes the order status update message to the corresponding queue, and at the same time, the first-type information platform can obtain the logistics information provided by the logistics provider cooperated with the platform. Accordingly, the order information management device calls the fulfillment interface of the first-type information platform after obtaining the order status update message, and obtains the fulfillment status of the new order and the latest fulfillment related information according to the information such as the order identification carried in the order fulfillment message. After obtaining the fulfillment status and the latest fulfillment related information of the new order, the fulfillment interface of the second-type information platform is called to change the order status of the new order on the second-type information platform into the fulfillment status and update the fulfillment related information. The second-type information platform performs synchronous fulfillment feedback to the order information management device, and displays the latest order status information to the user who placed the order at the front end of the platform. The order information management device updates the order status synchronization record according to the feedback result.

When the user who placed the order cancels the order, the target user needs to further review the order cancellation request to determine whether the order can be cancelled. First, the first-type information platform will push an order closing message, to make that the order information management device to call the order closing interface of the second-type of information platform to close the new order to be confirmed whether to be cancelled, to remind the target user to suspend the order fulfillment. Upon the order information management device obtaining a message that the order cancellation audit of the target user on the second-type information platform is approved, the order information management device will call the order cancellation interface of the second-type information platform to cancel the new order and release the order inventory; upon the order information management device obtaining a message that the order cancellation audit of the target user on the second-type information platform fails, the order information management device will call an order restart interface of the second-type information platform to reopen the new order which has been closed, and perform a fulfillment operation according to a conventional fulfillment process. In this process, all the closing, cancellation or restart of the order will be recorded in the order information management device, so as to check whether the order information status on the first-type information platform and the order information status on the second-type information platform are consistent.

The embodiment of the present disclosure synchronizes the order information of the new order to the second-type information platform for the target user upon the message of the new order of the target user on at least one first-type information platform being obtained under the condition that the target user uses multiple information platforms, so as to realize the summary management of all order information on one main information platform; upon an order status update message of a new order being obtained, the updated order status information of the new order is synchronized from the message source terminal on the first-type information platform and the second-type information platform to the non-message source terminal to complete the synchronous management of the order information, so that the order status generated on the first-type information platform can be kept consistent with that on the corresponding first-type information platform and second-type information platform; the first-type information platform and the second-type information platform are different order information sources and information management platforms for the target user, and the second-type information platform is the main order information summary management platform, so that a user can manage the orders of this information platform and the order information from other information platforms on one second-type information platform at the same time without platform jump, which avoids the situation of low information processing efficiency in the unified management of order information on different information platforms, realizes the order information fusion and two-way information synchronization of different types of e-commerce platforms, and improves the order information processing efficiency.

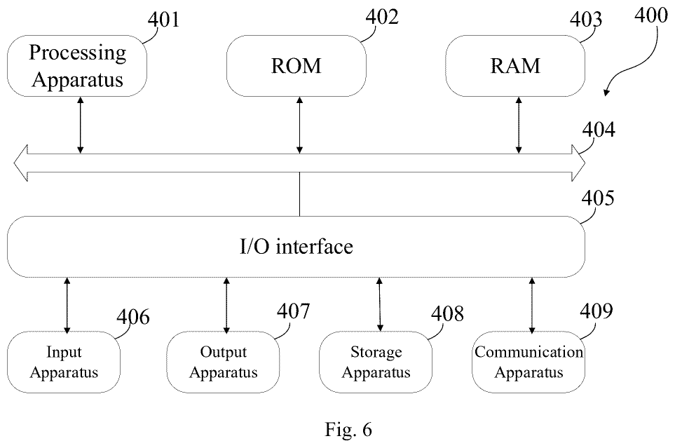

FIG. 6 is a schematic structural diagram of an electronic apparatus provided by an embodiment of the present disclosure. Referring to FIG. 6, FIG. 6 illustrates a schematic structural diagram of an electronic device 400 (for example, a terminal device or a server in FIG. 6) suitable for implementing some embodiments of the present disclosure. The terminal devices in some embodiments of the present disclosure may include but are not limited to mobile terminals such as a mobile phone, a notebook computer, a digital broadcasting receiver, a personal digital assistant (PDA), a portable Android device (PAD), a portable media player (PMP), a vehicle-mounted terminal (e.g., a vehicle-mounted navigation terminal) or the like, and fixed terminals such as a digital TV, a desktop computer, or the like. The electronic device illustrated in FIG. 6 is merely an example, and should not pose any limitation to the functions and the range of use of the embodiments of the present disclosure.

As illustrated in FIG. 6, the electronic device 400 may include a processing apparatus 401 (e.g., a central processing unit, a graphics processing unit, etc.), which can perform various suitable actions and processing according to a program stored in a read-only memory (ROM) 402 or a program loaded from a storage apparatus 408 into a random-access memory (RAM) 403. The RAM 403 further stores various programs and data required for operations of the electronic device 400. The processing apparatus 401, the ROM 402, and the RAM 403 are interconnected by means of a bus 404. An input/output (I/O) interface 405 is also connected to the bus 404.

Usually, the following apparatus may be connected to the I/O interface 405: an input apparatus 406 including, for example, a touch screen, a touch pad, a keyboard, a mouse, a camera, a microphone, an accelerometer, a gyroscope, or the like; an output apparatus 407 including, for example, a liquid crystal display (LCD), a loudspeaker, a vibrator, or the like; a storage apparatus 408 including, for example, a magnetic tape, a hard disk, or the like; and a communication apparatus 409. The communication apparatus 409 may allow the electronic device 400 to be in wireless or wired communication with other devices to exchange data. While FIG. 6 illustrates the electronic device 400 having various apparatuses, it should be understood that not all of the illustrated apparatuses are necessarily implemented or included. More or fewer apparatuses may be implemented or included alternatively.

Particularly, according to some embodiments of the present disclosure, the processes described above with reference to the flowcharts may be implemented as a computer software program. For example, some embodiments of the present disclosure include a computer program product, which includes a computer program carried by a non-transitory computer-readable medium. The computer program includes program codes for performing the methods shown in the flowcharts. In such embodiments, the computer program may be downloaded online through the communication apparatus 409 and installed, or may be installed from the storage apparatus 408, or may be installed from the ROM 402. When the computer program is executed by the processing apparatus 401, the above-mentioned functions defined in the methods of some embodiments of the present disclosure are performed.

Names of messages or information exchanged among multiple devices in the embodiment of the present disclosure are only used for illustrative purposes, and are not used to limit the scope of these messages or information.

The electronic apparatus provided by the embodiment of the present disclosure belongs to a same inventive concept as the order information management method provided by the above embodiment, and the technical details not described in detail in this embodiment can be found in the above embodiment, and this embodiment has the same beneficial effects as the above embodiment.

An embodiment of the present disclosure provides a computer storage medium, on which a computer program is stored, upon the computer program being executed by a processor, the order information management method provided in the above-mentioned embodiment is realized.

The storage medium may be a non-transitory storage medium.

It should be noted that the above-mentioned computer-readable medium in the present disclosure may be a computer-readable signal medium or a computer-readable storage medium or any combination thereof. For example, the computer-readable storage medium may be, but not limited to, an electric, magnetic, optical, electromagnetic, infrared, or semiconductor system, apparatus or device, or any combination thereof. More specific examples of the computer-readable storage medium may include but not be limited to: an electrical connection with one or more wires, a portable computer disk, a hard disk, a random-access memory (RAM), a read-only memory (ROM), an erasable programmable read-only memory (EPROM), or a flash memory, an optical fiber, a compact disk read-only memory (CD-ROM), an optical storage device, a magnetic storage device, or any appropriate combination of them. In the present disclosure, the computer-readable storage medium may be any tangible medium containing or storing a program that can be used by or in combination with an instruction execution system, apparatus or device. In the present disclosure, the computer-readable signal medium may include a data signal that propagates in a baseband or as a part of a carrier and carries computer-readable program codes. The data signal propagating in such a manner may take a plurality of forms, including but not limited to an electromagnetic signal, an optical signal, or any appropriate combination thereof. The computer-readable signal medium may also be any other computer-readable medium than the computer-readable storage medium. The computer-readable signal medium may send, propagate or transmit a program used by or in combination with an instruction execution system, apparatus or device. The program code contained on the computer-readable medium may be transmitted by using any suitable medium, including but not limited to an electric wire, a fiber-optic cable, radio frequency (RF) and the like, or any appropriate combination of them.

In some implementation modes, the client and the server may communicate with any network protocol currently known or to be researched and developed in the future such as hypertext transfer protocol (HTTP), and may communicate (via a communication network) and interconnect with digital data in any form or medium. Examples of communication networks include a local area network (LAN), a wide area network (WAN), the Internet, and an end-to-end network (e.g., an ad hoc end-to-end network), as well as any network currently known or to be researched and developed in the future.

The above-mentioned computer-readable medium may be included in the above-mentioned electronic device, or may also exist alone without being assembled into the electronic device.

The above-mentioned computer-readable medium carries one or more programs, and when the one or more programs are executed by the electronic device, the electronic device is caused to:

Upon the message of the new order of the target user on at least one first-type information platform being obtained, the order information of the new order is synchronized to the second-type information platform of the target user;
upon the order status update message of the new order being obtained, the updated order status information of the new order is synchronized from the message source terminal on the first-type information platform and the second-type information platform to the non-message source terminal, so as to complete the synchronous management of the order information;
the first-type information platform and the second-type information platform are different order information sources and information management platforms for the target user, and the second-type information platform is a main order information summary management platform.

The computer program codes for performing the operations of the present disclosure may be written in one or more programming languages or a combination thereof. The above-mentioned programming languages include but are not limited to object-oriented programming languages such as Java, Smalltalk, C++, and also include conventional procedural programming languages such as the “C” programming language or similar programming languages. The program code may be executed entirely on the user's computer, partly on the user's computer, as a stand-alone software package, partly on the user's computer and partly on a remote computer, or entirely on the remote computer or server. In the scenario related to the remote computer, the remote computer may be connected to the user's computer through any type of network, including a local area network (LAN) or a wide area network (WAN), or the connection may be made to an external computer (for example, through the Internet using an Internet service provider).

The flowcharts and block diagrams in the accompanying drawings illustrate the architecture, functionality, and operation of possible implementations of systems, methods, and computer program products according to various embodiments of the present disclosure. In this regard, each block in the flowcharts or the block diagrams may represent a module, a program segment, or a portion of codes, including one or more executable instructions for implementing specified logical functions. It should also be noted that, in some alternative implementations, the functions noted in the blocks may also occur out of the order noted in the accompanying drawings. For example, two blocks shown in succession may, in fact, can be executed substantially concurrently, or the two blocks may sometimes be executed in a reverse order, depending upon the functionality involved. It should also be noted that, each block of the block diagrams and/or flowcharts, and combinations of blocks in the block diagrams and/or flowcharts, may be implemented by a dedicated hardware-based system that performs the specified functions or operations, or may also be implemented by a combination of dedicated hardware and computer instructions.

The units involved in the embodiments of the present disclosure may be implemented in software or hardware. Among them, the name of the unit does not constitute a limitation of the unit itself under certain circumstances. For example, a first acquisition unit can also be described as “a unit that obtains at least two Internet Protocol addresses”.

The functions described herein above may be performed, at least partially, by one or more hardware logic components. For example, without limitation, available exemplary types of hardware logic components include: a field programmable gate array (FPGA), an application specific integrated circuit (ASIC), an application specific standard product (ASSP), a system on chip (SOC), a complex programmable logical device (CPLD) and so on.

In the context of the present disclosure, the machine-readable medium may be a tangible medium that may include or store a program for use by or in combination with an instruction execution system, apparatus or device. The machine-readable medium may be a machine-readable signal medium or a machine-readable storage medium. The machine-readable medium includes, but is not limited to, an electrical, magnetic, optical, electromagnetic, infrared, or semi-conductive system, apparatus or device, or any suitable combination of the foregoing. More specific examples of machine-readable storage medium include electrical connection with one or more wires, portable computer disk, hard disk, random-access memory (RAM), read-only memory (ROM), erasable programmable read-only memory (EPROM) or flash memory, optical fiber, portable compact disk read-only memory (CD-ROM), optical storage device, magnetic storage device, or any suitable combination of the foregoing.

According to one or more embodiments of the present disclosure, [Example 1] provides an order information management method, and the method includes:
upon obtaining a message of a new order of a target user on at least one first-type information platform, synchronizing order information of the new order to a second-type information platform of the target user; and
upon obtaining an order status update message of the new order, synchronizing updated order status information of the new order from a message source terminal on the first-type information platform and the second-type information platform to a non-message source terminal, so as to complete synchronous management of the order information;
the first-type information platform and the second-type information platform are different order information sources and different information management platforms of the target user, and the second-type information platform is a main order information summary management platform.

According to one or more embodiments of the present disclosure, [Example 2] provides an order information management method which further comprises:
in some implementations, the order status update message is an order fulfillment message, and the synchronizing updated order status information of the new order from a message source terminal on the first-type information platform and the second-type information platform to a non-message source terminal comprises:
calling a fulfillment interface of the message source terminal to obtain the updated order status information of the new order at the message source terminal according to the order fulfillment message; and
calling a fulfillment interface of the non-message source terminal to synchronize the updated order status information to the non-message source terminal.

According to one or more embodiments of the present disclosure, [Example 3] provides an order information management method, which comprises:
in some implementations, in the case where the message source terminal is the first-type information platform, and the non-message source terminal is the second-type information platform, the synchronizing updated order status information of the new order from a message source terminal on the first-type information platform and the second-type information platform to a non-message source terminal comprises:
calling a fulfillment interface of the first-type information platform to obtain a fulfillment status and currently latest fulfillment related information of the new order according to the order fulfillment message; and
calling a fulfillment interface of the second-type information platform to change an order status of the new order on the second-type information platform into the fulfillment status, and update the fulfillment related information.

According to one or more embodiments of the present disclosure, [Example 4] provides an order information management method, which further comprises:
in some implementations, in the case where the message source terminal is the second-type information platform, and the non-message source terminal is the first-type information platform, the synchronizing updated order status information of the new order from a message source terminal on the first-type information platform and the second-type information platform to a non-message source terminal comprises:
calling a fulfillment interface of the second-type information platform to obtain a fulfillment status and initial fulfillment related information of the new order according to the order fulfillment message;
calling a logistics service interface on the first-type information platform to obtain currently latest fulfillment related information according to the initial fulfillment related information; and
calling a fulfillment interface on the first-type information platform to change an order status of the new order on the first-type information platform into the fulfillment status, and update the currently latest fulfillment related information.

According to one or more embodiments of the present disclosure, [Example 5] provides an order information management method which further comprises:
in some implementations, in the case where the order status update message is an order cancellation message, the synchronizing updated order status information of the new order from a message source terminal on the first-type information platform and the second-type information platform to a non-message source terminal comprises:
upon the message source terminal of the order cancellation message being the first-type information platform, calling an order closing interface of the second-type information platform to close the new order, and processing the new order according to an order cancellation audit result of the target user.

According to one or more embodiments of the present disclosure, [Example 6] provides an order information management method, which further comprises:
in some implementations, the processing the new order according to an order cancellation audit result of the target user comprises:
upon obtaining a message that the order cancellation audit of the target user on the second-type information platform is approved, calling an order cancellation interface of the second-type information platform to cancel the new order and release an order inventory; and
upon obtaining a message that the order cancellation audit of the target user on the second-type information platform fails, calling an order restart interface of the second-type information platform to reopen the new order which has been closed.

According to one or more embodiments of the present disclosure, [Example 7] provides an order information management method, which further comprises:
in some implementations, the order information management method further comprises:
performing an order synchronization record according to the message of the new order and the order status update message; and
finding order information that fails to be synchronized according to the order synchronization record and each synchronization feedback record, and re-synchronizing the order information that fails to be synchronized.

According to one or more embodiments of the present disclosure, [Example 8] provides an order information management device, which comprises:
a new order synchronization module, configured to, in response to obtaining a message of a new order of a target user on at least one first-type information platform, synchronize order information of the new order to a second-type information platform of the target user; and
an order status synchronization module, configured to, in response to obtaining an order status update message of the new order, synchronize updated order status information of the new order from a message source terminal on the first-type information platform and the second-type information platform to a non-message source terminal, so as to complete synchronous management of the order information;
the first-type information platform and the second-type information platform are different order information sources and different information management platforms of the target user, and the second-type information platform is a main order information summary management platform.

According to one or more embodiments of the present disclosure, [Example 9] provides an order information management device, which further comprises:
in one embodiment, the order status update message is an order fulfillment message, and the order status synchronization module is configured to:
call a fulfillment interface of the message source terminal to obtain the updated order status information of the new order at the message source terminal according to the order fulfillment message; and
call a fulfillment interface of the non-message source terminal to synchronize the updated order status information to the non-message source terminal.

According to one or more embodiments of the present disclosure, [Example 10] provides an order information management device, which further comprises:
in an implementation, in the case where the message source terminal is the first-type information platform and the non-message source terminal is the second-type information platform, the order status synchronization module is further configured to:
call a fulfillment interface of the first-type information platform to obtain a fulfillment status and currently latest fulfillment related information of the new order according to the order fulfillment message; and
call a fulfillment interface of the second-type information platform to change an order status of the new order on the second-type information platform into the fulfillment status, and update the fulfillment related information.

According to one or more embodiments of the present disclosure, [Example 11] provides an order information management device, which further comprises:
in an implementation method, in the case where the message source terminal is the second-type information platform and the non-message source terminal is the first-type information platform, the order status synchronization module is further configured to:
call a fulfillment interface of the second-type information platform to obtain a fulfillment status and initial fulfillment related information of the new order according to the order fulfillment message;
call a logistics service interface on the first-type information platform to obtain currently latest fulfillment related information according to the initial fulfillment related information; and
call a fulfillment interface on the first-type information platform to change an order status of the new order on the first-type information platform into the fulfillment status, and update the currently latest fulfillment related information.

According to one or more embodiments of the present disclosure, [Example 12] provides an order information management device, which further comprises:
in an implementation method, in the case where the order status update message is an order cancellation message, the order status synchronization module is further configured to:
upon the message source terminal of the order cancellation message being the first-type information platform, calling an order closing interface of the second-type information platform to close the new order, and processing the new order according to an order cancellation audit result of the target user.

According to one or more embodiments of the present disclosure, [Example 13] provides an order information management device, which further comprises:
in an implementation method, the order status synchronization module is further configured to:
upon obtaining a message that the order cancellation audit of the target user on the second-type information platform is approved, call an order cancellation interface of the second-type information platform to cancel the new order and release an order inventory; and
upon obtaining a message that the order cancellation audit of the target user on the second-type information platform fails, call an order restart interface of the second-type information platform to reopen the new order which has been closed.

According to one or more embodiments of the present disclosure, [Example 14] provides an order information management device, which further comprises:
in an implementation method, the order information management device further comprises an order synchronization checking module, which is configured to:
perform an order synchronization record according to the message of the new order and the order status update message;
find order information that fails to be synchronized according to the order synchronization record and each synchronization feedback record, and re-synchronize the order information that fails to be synchronized.

It will be appreciated by those skilled in the art that the scope of the disclosure involved herein is not limited to the technical solutions formed by a specific combination of the technical features described above, and shall cover other technical solutions formed by any combination of the technical features described above or equivalent features thereof without departing from the concept of the present disclosure. For example, the technical features described above may be mutually replaced with the technical features having similar functions disclosed herein (but not limited thereto) to form new technical solutions.

In addition, while operations have been described in a particular order, it shall not be construed as requiring that such operations are performed in the stated specific order or sequence. Under certain circumstances, multitasking and parallel processing may be advantageous. Similarly, while some specific implementation details are included in the above discussions, these shall not be construed as limitations to the present disclosure. Some features described in the context of a separate embodiment may also be combined in a single embodiment. Rather, various features described in the context of a single embodiment may also be implemented separately or in any appropriate sub-combination in a plurality of embodiments.

Although the present subject matter has been described in a language specific to structural features and/or logical method acts, it will be appreciated that the subject matter defined in the appended claims is not necessarily limited to the particular features and acts described above. Rather, the particular features and acts described above are merely exemplary forms for implementing the claims.

1. An order information management method, comprising:
in response to obtaining a message of a new order of a target user on at least one first-type information platform, synchronizing order information of the new order to a second-type information platform of the target user; and
in response to obtaining an order status update message of the new order, synchronizing updated order status information of the new order from a message source terminal on the first-type information platform and the second-type information platform to a non-message source terminal, so as to complete synchronous management of the order information,
wherein the first-type information platform and the second-type information platform are different order information sources and different information management platforms of the target user, and the second-type information platform is a main order information summary management platform.

2. The method according to claim 1, wherein the order status update message is an order fulfillment message, and the synchronizing the updated order status information of the new order from the message source terminal on the first-type information platform and the second-type information platform to the non-message source terminal comprises:
calling a fulfillment interface of the message source terminal to obtain the updated order status information of the new order at the message source terminal according to the order fulfillment message; and
calling a fulfillment interface of the non-message source terminal to synchronize the updated order status information to the non-message source terminal.

3. The method according to claim 2, wherein in a case where the message source terminal is the first-type information platform, and the non-message source terminal is the second-type information platform, the synchronizing the updated order status information of the new order from the message source terminal on the first-type information platform and the second-type information platform to the non-message source terminal comprises:
calling a fulfillment interface of the first-type information platform to obtain a fulfillment status and currently latest fulfillment related information of the new order according to the order fulfillment message; and
calling a fulfillment interface of the second-type information platform to change an order status of the new order on the second-type information platform into the fulfillment status, and update the fulfillment related information.

4. The method according to claim 2, wherein in a case where the message source terminal is the second-type information platform, and the non-message source terminal is the first-type information platform, the synchronizing the updated order status information of the new order from the message source terminal on the first-type information platform and the second-type information platform to the non-message source terminal comprises:
calling a fulfillment interface of the second-type information platform to obtain a fulfillment status and initial fulfillment related information of the new order according to the order fulfillment message;
calling a logistics service interface on the first-type information platform to obtain currently latest fulfillment related information according to the initial fulfillment related information; and
calling a fulfillment interface on the first-type information platform to change an order status of the new order on the first-type information platform into the fulfillment status, and update the currently latest fulfillment related information.

5. The method according to claim 1, wherein in a case where the order status update message is an order cancellation message, the synchronizing the updated order status information of the new order from the message source terminal on the first-type information platform and the second-type information platform to the non-message source terminal comprises:
in response to the message source terminal of the order cancellation message being the first-type information platform, calling an order closing interface of the second-type information platform to close the new order, and processing the new order according to an order cancellation audit result of the target user.

6. The method according to claim 5, wherein the processing the new order according to the order cancellation audit result of the target user comprises:
in response to obtaining a message that the order cancellation audit of the target user on the second-type information platform is approved, calling an order cancellation interface of the second-type information platform to cancel the new order and release an order inventory; and
in response to obtaining a message that the order cancellation audit of the target user on the second-type information platform fails, calling an order restart interface of the second-type information platform to reopen the new order which has been closed.

7. The method according to claim 1, further comprising:
performing an order synchronization record according to the message of the new order and the order status update message; and
finding order information that fails to be synchronized according to the order synchronization record and each synchronization feedback record, and re-synchronizing the order information that fails to be synchronized.

8. An order information management device, comprising:
a new order synchronization module, configured to, in response to obtaining a message of a new order of a target user on at least one first-type information platform, synchronize order information of the new order to a second-type information platform of the target user; and
an order status synchronization module, configured to, in response to obtaining an order status update message of the new order, synchronize updated order status information of the new order from a message source terminal on the first-type information platform and the second-type information platform to a non-message source terminal, so as to complete synchronous management of the order information,
wherein the first-type information platform and the second-type information platform are different order information sources and different information management platforms of the target user, and the second-type information platform is a main order information summary management platform.

9. An order information management system, comprising:
at least one first-type information platform, one second-type information platform and an order management device running on the first-type information platform,
wherein the first-type information platform and the second-type information platform are different order information sources and different information management platforms of a same target user, and the second-type information platform is a main order information summary management platform; and
the order management device is configured to realize synchronous management of the order information of the first-type information platform between the first-type information platform and the second-type information platform through the order information management method according to claim 1.

10. An electronic apparatus, comprising:
one or more processors;
a storage device, configured to store one or more programs, and
upon the one or more programs being executed by the one or more processors, the one or more processors realize the order information management method according to claim 1.

11. A storage medium containing computer executable instructions for executing the order information management method according to claim 1 upon the computer executable instructions being executed by a computer processor.

12. The method according to claim 3, wherein the fulfillment status comprises at least one of a status of pre-delivery, in-delivery, post-delivery and sign-for, and the fulfillment related information comprises at least one content of change time and logistics information of each fulfillment status.

13. The method according to claim 4, wherein the initial fulfillment related information refers to relevant information of the target user when delivering goods on the second-type information platform.

14. The method according to claim 5, wherein after the order information of the new order is synchronized to the second-type information platform, the new order exists in both the first-type information platform that generates the order and the second-type information platform that performs order summary and fusion management.

15. The order information management device according to claim 8, wherein the order status update message is an order fulfillment message, and the order status synchronization module is configured to: call a fulfillment interface of the message source terminal to obtain the updated order status information of the new order at the message source terminal according to the order fulfillment message; and call a fulfillment interface of the non-message source terminal to synchronize the updated order status information to the non-message source terminal.

16. The order information management device according to claim 8, wherein in a case where the message source terminal is the first-type information platform and the non-message source terminal is the second-type information platform, the order status synchronization module is further configured to: call a fulfillment interface of the first-type information platform to obtain a fulfillment status and currently latest fulfillment related information of the new order according to the order fulfillment message; and call a fulfillment interface of the second-type information platform to change an order status of the new order on the second-type information platform into the fulfillment status, and update the fulfillment related information.

17. The order information management device according to claim 8, wherein in a case where the message source terminal is the second-type information platform and the non-message source terminal is the first-type information platform, the order status synchronization module is further configured to: call a fulfillment interface of the second-type information platform to obtain a fulfillment status and initial fulfillment related information of the new order according to the order fulfillment message; call a logistics service interface on the first-type information platform to obtain currently latest fulfillment related information according to the initial fulfillment related information; and call a fulfillment interface on the first-type information platform to change an order status of the new order on the first-type information platform into the fulfillment status, and update the currently latest fulfillment related information.

18. The order information management device according to claim 8, wherein in a case where the order status update message is an order cancellation message, the order status synchronization module is further configured to: upon the message source terminal of the order cancellation message being the first-type information platform, call an order closing interface of the second-type information platform to close the new order, and process the new order according to a result of order cancellation audit of the target user.

19. The order information management device according to claim 18, wherein the order status synchronization module is further configured to:
upon obtaining a message that the order cancellation audit of the target user on the second-type information platform is approved, call an order cancellation interface of the second-type information platform to cancel the new order and release an order inventory; or
upon obtaining a message that the order cancellation audit of the target user on the second-type information platform fails, call an order restart interface of the second-type information platform to reopen the new order which has been closed.

20. The order information management device according to claim 8, further comprises an order synchronization checking module, which is configured to:
perform an order synchronization record according to the message of the new order and the order status update message; and
find order information that fails to be synchronized according to the order synchronization record and each synchronization feedback record, and re-synchronize the order information that fails to be synchronized.
